(19) United States
(12) Patent Application Publication
(10) Pub. No.: US 2026/0126318 A1
(43) Pub. Date: May 7, 2026

(54) WEIGHING SYSTEM AND COUPLING STRIP

(71) Applicant: Sartorius Lab Instruments GmbH & Co. KG, Goettingen (DE)

(72) Inventors: Matthias GEISLER, Noerten-Hardenberg (DE); Michael MUELLER, Goettingen (DE); Ulrich BAJOHR, Brakel (DE)

(21) Appl. No.: 19/434,551

(22) Filed: Dec. 29, 2025

Related U.S. Application Data
(63) Continuation of application No. PCT/EP2024/066972, filed on Jun. 18, 2024.

(30) Foreign Application Priority Data
Jun. 29, 2023 (DE) 10 2023 117 237.9

(51) Int. Cl. G01G 21/18

(52) U.S. Cl. CPC G01G 21/18

(57) ABSTRACT

A weighing system having a lever with a first arm (241), a second arm (242) and a coupling belt (30) with two functional areas having reduced width and reduced thickness compared to immediately adjacent areas, namely
a thin-section joint (32), having a thickness that, in the longitudinal direction of the coupling belt, initially decreases and, after reaching a minimum thickness, increases, to define a localized first pivot axis (321) extending parallel to the width direction and perpendicular to the longitudinal direction of the coupling belt, and
a resilient region (34, 34′) having a thickness that, in the longitudinal direction of the coupling belt, initially decreases, then, after reaching a minimum thickness, remains constant over a distance corresponding to at least its width, and then increases again in order to define a continuous array of second pivot axes (341) parallel to the first pivot axis.

### CROSS REFERENCE TO RELATED APPLICATION

This is a Continuation of International Application PCT/EP2024/066972, which has an international filing date of Jun. 18, 2024, and the disclosure of which is incorporated in its entirety into the present Continuation by reference. This Continuation also claims foreign priority under 35 U.S. C. § 119(a)-(d) to and also incorporates by reference, in its entirety, German Patent Application DE 10 2023 117 237.9 filed on Jun. 29, 2023.

### FIELD

The invention relates to a weighing system comprising a base, a load receptor coupled to the base by a parallel linkage arrangement so as to be vertically movable, and a lever articulated to the base by a lever joint so as to be pivotable, the lever having a first lever arm arranged on one side of the lever joint and a second lever arm arranged on the other side of the lever joint and configured to accommodate a sensor arrangement, wherein the first lever arm is coupled to the load receptor by a coupling belt so as to transmit vertical forces, coupling belt the coupling belt being fixed both to the first lever arm and to the load receptor.

### BACKGROUND

The invention further relates to a coupling belt consisting of a sheet metal strip, for coupling a load receptor of a weighing system and a first lever arm of a lever of the weighing system so as to transmit vertical forces.

Conventional weighing systems and coupling belts for them are known from DE 30 12 344 A1.

The central component of an electronic scale, in particular one perating on the principle of electromagnetic compensation, is its weighing system. The term “weighing system” is understood here to mean the mechanical lever mechanism with which a weighing goods carrier of the scale, which serves to hold the material to be weighed, is connected to the electronic sensor of the scale, typically a moving coil arrangement with optical lever position detection. The weighing system comprises a base by which it can be fixed to a platform or housing of the scale. A load receptor is articulated to this base via a parallel linkage arrangement, often referred to as a Roberval mechanism. The weighing goods carrier mentioned above is fixed directly or indirectly to the load receptor when the scale is in its final assembled state. The parallel linkage arrangement serves to prevent the load receptor or the weighing goods carrier from tilting, at least in the case of small deflections of the load receptor, which occur roughly on a circular arc with a radius equal to the length of the parallel linkage. Furthermore, a typical weighing system comprises a lever for transmitting distance and force, which is articulated at the base via a lever joint. A first lever arm of this lever is coupled to the load receptor in order to transmit its movement caused by the weight of the weighing material to the lever. A second lever arm of the lever is typically equipped with a mount for lever-side components of an electronic sensor, in particular a moving coil, which interacts in a manner that is generally known and thus not further relevant here, with other base-side sensor components mounted on the base, in particular a magnetic pot. Such a weighing system thus represents the “heart” of a scale, wherein similar weighing systems can be used in scales that are otherwise equipped differently.

The coupling between the first lever arm and the load receptor mentioned above requires a connection, often referred to as a coupling, which is suitable for transmitting vertical forces between the load receptor and the first lever arm on the one hand, and which is sufficiently flexible on the other hand to achieve decoupling with regard to any non-vertical force components. As mentioned, a parallel linkage mechanism can prevent the load receptor from tilting, but it cannot prevent its circular arc movement comprising horizontal movement components alongside the vertical ones. However, these must not be transferred to the lever, as the corresponding non-vertical force components would distort the measured weight value, which is unacceptable, especially in the case of extremely high-resolution precision scales. In order to combine both requirements, namely vertical coupling and non-vertical decoupling, the aforementioned couplings, as described in the aforementioned background publication, can be configured in the form of thin sheet metal strips, i.e. as so-called coupling belts. If the coupling belt is sufficiently thin, non-vertical decoupling sufficient even for extremely high-resolution scales can be achieved. However, it has been found that such weighing systems are extremely susceptible to lateral acceleration forces, such as those typically occurring during transport, especially when shipping scales. Therefore, great care must be taken when packaging the scales to ensure that they arrive at the recipient with the coupling belts intact. The theoretical approach of fixing the coupling belt to the load receptor and first lever arm only after the scale has been set up at its destination is not practicable for calibration reasons.

DE 32 42 954 A1 describes a coupling configured as a coupling rod, which has a functional area tapered in thickness and width near its respective fixing areas on the load receptor and first lever arm. Together, these functional areas are intended to generate the elasticity of the coupling required for non-vertical decoupling. Although such coupling rods are more robust than coupling belts, they do not achieve the degree of non-vertical decoupling required for extremely high-resolution precision scales.

As examples of the exemplary areas of application for the present invention, comparators and high-resolution precision scales, in particular ultramicro scales and micro scales with load ranges between 2 g and 200 g at resolutions of 0.1 μg, 1 μm, or up to 5 μg, are mentioned.

### SUMMARY

One object of the present invention is to provide a weighing system and a coupling belt for it that enable the construction of extremely high-resolution and at the same time robust scales.

According to one formulation this object is achieved in conjunction with features of a conventional weighing system in that the coupling belt has two functional areas which are characterized by reduced width and reduced thickness compared to immediately adjacent areas, namely
a thin-section joint, which has a thickness that, in the longitudinal direction of the coupling belt, initially decreases and then, after reaching a minimum thickness at a specific point, increases again in order to define a localized first pivot axis extending parallel to the width direction and perpendicular to the length direction of the coupling belt, and
a resilient region which has a thickness that, in the longitudinal direction of the coupling belt, initially decreases, then, after reaching a minimum thickness, remains constant over a distance corresponding to at least its width, and then increases again in order to define a continuous array of second pivot axes parallel to the first pivot axis.

This object is further achieved in conjunction with features of a conventional weighing system in that two functional areas are formed at a distance from each other in the longitudinal direction of the sheet metal strip, which are characterized by a reduced width and reduced thickness compared to immediately adjacent areas, namely
a thin-section joint, which has a thickness that, in the longitudinal direction of the coupling belt, initially decreases and then, after reaching a minimum thickness at a specific point, increases again in order to define a localized first pivot axis extending parallel to the width direction and perpendicular to the length direction of the coupling belt, and
a resilient region which has a thickness that, in the longitudinal direction of the coupling belt, initially decreases, then, after reaching a minimum thickness, remains constant over a distance corresponding to at least its width, and then increases again in order to define a continuous array of second pivot axes parallel to the first pivot axisthin-section joint.

Exemplary embodiments are the subject of the dependent claims.

One notable feature of the present invention lies in the specific shape of the coupling belt, which is, for example, made of a spring-elastic metal material, e.g., a copper-beryllium alloy. First, the idea of multiple functional areas, which are characterized by tapering in thickness and width from the immediately adjacent areas, hereinafter referred to as secondary areas, is transferred from systems with coupling rods to systems with coupling belts. However, the special configuration of the functional areas, which cannot be adopted due to the different basic shapes of coupling rods on the one hand and coupling belts on the other, plays a material role in the effectiveness of the invention. In particular, the functional area referred to as the thin-section joint is configured such that it forms a precisely localized first pivot axis around which the immediately adjacent secondary areas can perform a precisely defined pivoting movement relative to each other. The second functional area, on the other hand, forms a long-distance resilience region which, in contrast to the thin-section joint, does not define a precisely localized pivot axis, but rather an elongated pivot area. This can be understood as a continuous array of individual, parallel, second pivot axes, wherein the neighboring areas immediately adjacent to the resilience region can perform a pivoting movement relative to each other around (any) one or several of these second pivot axes simultaneously, depending on the specific forces acting in each individual case. For pure non-vertical decoupling of the load receptor and lever, two thin-section joints spaced apart from each other or a sufficiently long resilience region would possibly be sufficient. However, in terms of robustness against acceleration forces, such as those that occur in particular during the transport or shipment of weighing systems or complete scales, this special combination of thin-section joint and resilience region has proven to be particularly effective, without the mechanical interactions and force curves being fully understood in detail. The robustness achieved by the invention must rather be regarded as an unforeseen, surprising effect.

Starting from an immediately adjacent secondary area, the thickness curve of the thin-section joint can be described such that the thickness of the coupling belt here decreases in a particularly monotonous manner, i.e., without “counter-increases,” continues to decrease until it reaches the minimum thickness, and then immediately increases again, in particular also monotonically, until the thickness of the adjacent secondary area on the other side is reached. It has proven advantageous to configure the surface profile symmetrically, preferably both in the longitudinal direction and in the thickness direction. In particular, the thin-section joint may have a biconcave or bifacially V-shaped thickness profile in the longitudinal direction. In the former case, the surface profile on both main surfaces of the coupling belt follows a circular arc, with the vertices of the circular arcs on the front and back being colocalized in the longitudinal direction to form the sharply localized minimum thickness according to the invention. In the latter case, the surface profile of the two main surfaces of the coupling belt initially follows a straight downward slope and then a straight upward slope (V-shape), wherein the two contact lines of the descending and ascending slopes on the front and rear sides of the coupling belt are co-located in the longitudinal direction to form the sharply localized minimum thickness according to the invention. In principle, other thickness profiles are also feasible, but the ones mentioned have proven to be particularly advantageous in terms of manufacture, one preferred method of which will be discussed in more detail below.

The precise definition of the pivot axis provided by the thin-section joint can be enhanced by a width profile of the coupling belt that corresponds to the thickness profile. Thus, in a preferred further development of the invention, it is envisaged that the thin-section joint has a width that initially decreases monotonically in the longitudinal direction and, after reaching the minimum width at the point where the minimum thickness is located, increases monotonically again. Here, too, a symmetrical configuration is particularly advantageous. In particular, it may be provided that the thin-section joint has a biconcave or bilaterally V-shaped width profile in the longitudinal direction. In the first case, this means that the side edges of the coupling belt in the area of the thin-section joint each follow a circular arc, with the vertices of the circular arcs being colocalized with each other in the longitudinal direction and, in particular, also with the minimum thickness. In the second case, it is provided that the side edges of the coupling belt in the area of the thin-section joint are initially beveled in a straight line inwards and, after reaching the minimum width, immediately beveled again in a straight line outwards, wherein the two contact lines between the inward and outward slopes on both edges of the coupling belt are colocalized with each other in the longitudinal direction and preferably also with the minimum thickness.

The length of the thin-section joint, i.e., the distance between the two adjacent areas immediately bordering the thin-section joint on both sides, is preferably between 2 mm and 20 mm, in particular between 4 mm and 6 mm. The thickness of the thin-section joint at its minimum thickness is preferably between 10μm and 100 μm, in particular between 40 μm and 60 μm.

The same applies to the shaping of the resilience region, wherein, however—and this is a salient difference between the thin-section joint and the resilience region—the area of minimum thickness extends over a larger length of the coupling belt. The end areas of the resilience region, i.e., the transition areas to the immediately adjacent secondary areas, preferably have a bifacially rounded or sloping thickness profile in the longitudinal direction. In the first case, the surface profile of the two main surfaces between the immediately adjacent secondary area and the area of minimum thickness follows a circular path. In the second case, the surface profile follows a straight sloping line.

A shape corresponding to the thickness and width profile is also preferred for the resilience region. In other words, this means that the resilience region has a width that initially decreases in the longitudinal direction and then increases again after reaching a minimum width that is colocalized with the associated minimum thickness. The end areas of the resilience region can have a bilaterally rounded or straight sloping width profile in the longitudinal direction.

Advantageously, the length of the resilience region, i.e., the distance between the immediately adjacent secondary regions on both sides, is between 5 mm and 50 mm, in particular between 6 mm and 10 mm. The thickness of the resilience region in the area of its minimum thickness is preferably between 50μm and 150 μm, in particular between 80 μm and 120 μm.

The length of the entire coupling belt is preferably between 20 mm and 150 mm, in particular between 80 mm and 100 mm. The width of the coupling belt in the secondary areas is preferably between 5 mm and 10 mm.

In a particular embodiment of the invention, the coupling belt has not just one but several resilience regions. These can interact advantageously in terms of robustness, wherein each resilience region acts individually with regard to non-vertical decoupling, so that the overall achievable degree of decoupling is at least not impaired and in some cases can even be improved.

As described so far, the configuration of the coupling belt according to the invention allows more (thin joint) or less (resilience region(s)) sharply localized pivoting movements of the secondary areas of the coupling belt about pivoting axes oriented perpendicular to the length and parallel to the width. However, the direction of acceleration forces occurring during transport or shipping of weighing systems according to the invention is difficult to predict. It has therefore proven advantageous to additionally provide the coupling belt according to the invention with a lateral swivel area that allows swivel movements around swivel axes oriented perpendicular to the length and width directions. In particular, a further development of the invention may provide for an additional lateral swivel area on the coupling belt, especially in the longitudinal direction between the thin-section joint and the resilience region, which consists of one or more parallel webs extending in the longitudinal direction of the coupling belt, each of which webs has a web width that is less than the thickness of the coupling belt in this area. Due to this relative dimensioning, these webs are more easily bendable in the coupling belt plane defined by the length and width of the coupling belt than perpendicular thereto. This opens up a further degree of freedom of pivoting perpendicular to the degree of freedom of pivoting given by the thin-section joint and the resilience region; this further degree of freedom allows the absorption of correspondingly directed acceleration forces. This further increases the overall robustness of the weighing system or coupling belt according to the invention.

With regard to the manufacture of a coupling belt according to the invention, it has proven advantageous to use a method comprising the steps:
providing a coupling belt blank made of a spring-elastic metal sheet,
laser processing the coupling belt blank to form length sections of different thicknesses and/or widths.

Compared to machining processes, mechanical contactless laser processing has the advantage of not introducing mechanical stresses into the coupling belt. Compared to chemical processes, e.g., lithographic or etching processes, laser processing is significantly faster and less complex. In addition, it has proven to be extremely valuable in terms of flexibility in the configuration of the transition areas between functional and secondary areas.

Regardless of the specific processing method, the blank should preferably have a uniform thickness over its length, which is only amended by the processing in the functional area.

Further details and advantages of the invention are apparent from the following specific description and the drawings.

### BRIEF DESCRIPTION OF THE DRAWINGS

They show:

FIG. 1: a schematic representation of a weighing system according to the invention,

FIG. 2: a side view of a coupling belt according to the invention,

FIG. 3: a top view of the coupling belt of FIG. 2, and

FIG. 4: a top view of an alternative embodiment of a coupling belt according to the invention.

### DETAILED DESCRIPTION

Identical reference symbols in the figures indicate identical or analogous elements.

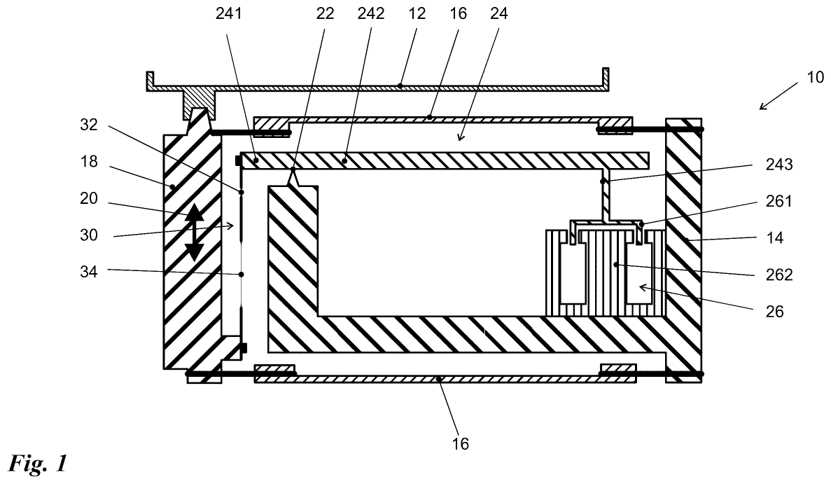

FIG. 1 shows a weighing system 10 according to the invention, already equipped with a weighing goods carrier 12. The weighing system 10 comprises a base 14 that serves as a reference point for all movements within the weighing system 10. A load receptor 18 is connected to the base 14 via a Roberval mechanism with two parallel linkages 16 and can move vertically (vertical movement arrow 20). The load receptor 18 is coupled to the weighing goods carrier 12 so that the weight of weighing goods placed on the weighing goods carrier 12 results in a vertical force being applied to the load receptor 18.

Furthermore, the base 14 is coupled to a lever 24 via a lever joint 22. The lever 24 has a first lever arm 241, shown on the left of the lever joint 22 in FIG. 1, and a second lever arm 242, shown on the right of the lever joint 22 in FIG. 1. The coupling between the base 14 and the lever 24 is configured such that the lever 24 can perform a pivoting movement around the lever joint 22 in the drawing plane of FIG. 3. A sensor mount 243 is arranged at the end of the second lever arm 242. The sensor mount 243 serves to accommodate lever-side sensor components 261, which can interact with base-side sensor components 262 of an electronic sensor 26 fixed to the base 14. In particular, the sensor 26 may be a moving coil arrangement that enables gravimetric measurement according to the principle of electromagnetic compensation known to those skilled in the art. However, the scope of the invention is not limited to such moving coil arrangements, and encompasses all feasible types of sensor technology.

In order to transfer the vertical weight forces exerted by the weighed material on the load receptor 18 to the lever 24, in particular its first lever arm 241, the load receptor 18 is connected to the first lever arm 241 through a coupling belt 30. In particular, the coupling belt 30 can be screwed or otherwise fixed to the load receptor 18 on one side and to the first lever arm 241 on the other. Since the deflection movements of both the load receptor 18 and the lever 24 are not purely linear in nature, but follow a circular arc movement, and since the weight forces to be measured act purely vertically, the force transmission via the coupling belt requires the vertical components to be transmitted with as little loss as possible and the non-vertical components to be decoupled.

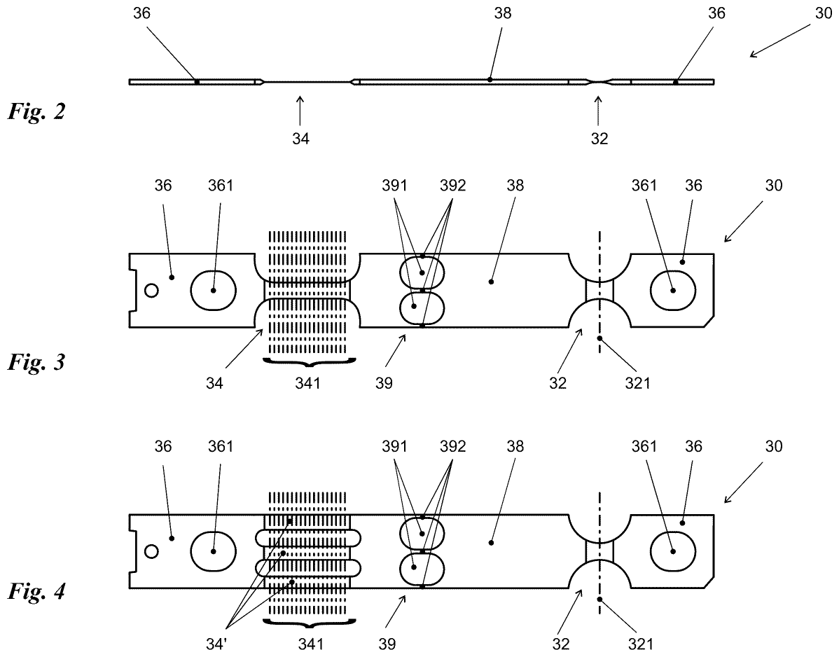

For this purpose, the coupling belt 30 has two functional areas, namely a thin-section joint 32 and a resilient region 34, the details of which will be described below in the context of FIGS. 2 and 3.

FIGS. 2 and 3 show one preferred embodiment of a coupling belt according to the invention, which can be used in particular for constructing a weighing system according to FIG. 1. FIGS. 2 and 3 will be described together below.

The coupling belt 30 is configured as a specially shaped sheet metal strip, preferably made of a spring-elastic material, in particular a copper-beryllium alloy. Its total length can be, for example, approximately 60 mm. The coupling belt 30 comprises several functional areas and areas arranged between or adjacent to them, which are generally referred to here as secondary areas. The end secondary areas 36 primarily serve to fix the coupling belt 30 to the load receptor 18 or to the first lever arm 241. They are provided with through holes 361 through which fixing screws can be passed for clamping fixation to the load receptor 18 or the first lever arm 241. A thin-section joint 32 adjacent to the right-hand end section 36 is provided as a first functional section in FIGS. 2 and 3. The thin-section joint 32 is characterized initially by a taper both in the thickness direction (see FIG. 2) and in the width direction (see FIG. 3). In the embodiment shown, both the thickness and width tapering are symmetrical and biconcave in nature. However, the radii of the biconcave constrictions are selected differently. In particular, the radius of the thickness tapering is selected to be significantly larger than that of the width tapering. In the embodiment shown, the total length of the width taper section is approximately twice as large as the total length of the thickness taper section. The latter can be, for example, approximately 3 mm, so that the former is approximately 6 mm with such dimensions. The thickness taper is largely responsible for the function of the thin-section joint 32. The decisive factor here is that there is a well-defined, well-localized thickness minimum, which creates a sharply localized pivot axis 321.

A second functional area is provided in FIGS. 2 and 3 in the form of a resilience region 34 adjacent to the left-hand terminal secondary area 36. This is also characterized by a taper in the thickness direction (see FIG. 2) and in the width direction (see FIG. 3). The tapering in the thickness direction takes the form of bifacially symmetrical sloping ramps, which lead to a longer section of constant, minimum thickness. The tapering in the width direction, on the other hand, is formed as bilateral curves that merge into a longer area of constant, minimum width. The total lengths of the tapered sections in the thickness and width directions are selected differently in the embodiment shown. In particular, the length of the tapered section in the width direction is selected to be longer than the length of the tapered section in the thickness direction. The latter can be approximately 6 mm, for example. The taper in the thickness direction is particularly responsible for the function of the resilience region 34. The decisive factor here is the existence of a longer section with a constant, minimum thickness, by which a continuous array of pivot axes 341 is created.

In the embodiment shown, a further functional area, namely the lateral swivel area 39, is provided within the central secondary area 38 located between the thin-section joint 32 and the resilience region 34. In the embodiment shown, this consists of two elongated through holes 391 adjacent to each other in the width direction of the coupling belt 30, which create a web 392 between each other and between themselves and the respective lateral edge of the secondary area 38. The width of these webs 392 is less than the thickness of the secondary area 38 at this point, resulting in pivotability in the coupling belt plane, i.e., in the drawing plane of FIG. 3. Embodiments in which more or less than the three parallel webs 392 shown in FIG. 3 are realized are also feasible. In particular, it is possible to configure the through holes 391 to be open at the sides, so that the marginal webs shown in FIG. 3 are omitted and the lateral swivel area 39 consists mostly of a centrally arranged web 392. This embodiment exhibits particularly high lateral swivel elasticity.

The interaction of the functional areas described, in particular the thin-section joint 32 and the resilience region 34, leads not only to the desired non-vertical decoupling of the load receptor 18 and the lever 24, but also to a particular robustness of the weighing system 10 with respect to acceleration forces. The packaging costs incurred when transporting such weighing systems can therefore be significantly reduced.

FIG. 4 shows an alternative configuration of the coupling belt 30, which instead of a single resilience region 34 has three parallel resilience regions 34′ spaced apart laterally from each other via through holes. This configuration further increases the robustness of the weighing system without noticeably impairing the decoupling of non-vertical force components. For further details, reference is made to the above comments on FIG. 3.

The embodiments discussed in the specific description and shown in the figures are only illustrative examples of the present invention. In light of the disclosure herein, a wide range of possible variations is available to those skilled in the art. In particular, there is considerable freedom with regard to the choice of base material for the coupling belt. In addition to embodiments made of a single material, coupling belt base bodies composed of several material components, for example by additive manufacturing processes, are also feasible. The specific dimensions must be adapted in particular to the planned use in scales, their intended load capacity, and resolution.

### LIST OF REFERENCES

10 weighing system
12 weighing goods carrier
14 base
16 parallel linkage
18 load receptor
20 vertical movement arrow
22 lever joint
24 lever
241 first lever arm
242 second lever arm
26 sensor
261 lever-side sensor component
262 base-side lever component
30 coupling belt
32 thin-section joint
321 pivot axis
34, 34′ resilien(t/ce) region
341 set of pivot axes
36 terminal/end secondary area
361 through hole
38 central secondary area
39 lateral swivel area
391 through hole
392 web

What is claimed is:

1. A weighing system comprising a base, a load receptor coupled to the base by a parallel linkage arrangement so as to be vertically movable, and a lever articulated to the base by a lever joint so as to be pivotable, the lever having a first lever arm arranged on one side of the lever joint and a second lever arm arranged on an opposite side of the lever joint and configured to accommodate a sensor arrangement,
wherein the first lever arm is coupled to the load receptor by a coupling belt so as to transmit vertical forces, the coupling belt being fixed both to the first lever arm and to the load receptor, and wherein the coupling belt has two functional areas which have reduced width and reduced thickness compared to immediately adjacent areas of the coupling belt, namely
a thin-section joint, which has a thickness that, in a longitudinal direction of the coupling belt, initially decreases and then, after reaching a minimum thickness at a specific point, increases again in order to define a localized first pivot axis extending parallel to a width direction of the coupling belt and perpendicular to the longitudinal direction of the coupling belt, and
a resilient region which has a thickness that, in the longitudinal direction of the coupling belt, initially decreases, then, after reaching a minimum thickness, remains constant over a distance corresponding to at least a width of the coupling belt, and then increases again so as to define a continuous array of second pivot axes parallel to the first pivot axis.

2. The weighing system according to claim 1,
wherein the thin-section joint has, in the longitudinal direction, a biconcave thickness profile or a bifacially V-shaped thickness profile.

3. The weighing system according to claim 1,
wherein the thin-section joint has a width that, in the longitudinal direction, initially decreases and then increases again after reaching a point-like minimum width colocalized with the minimum thickness.

4. The weighing system according to claim 3,
wherein the thin-section joint has, in the longitudinal direction, a biconcave width profile or a bilaterally V-shaped width profile.

5. The weighing system according to claim 1,
wherein the thin section joint has a length between 2 mm and 20 mm.

6. The weighing system according to claim 1,
wherein the thin-section joint has a thickness between 10 μm and 100 μm, at the minimum thickness of the thin-section joint.

7. The weighing system according to claim 1,
wherein end regions of the resilient region have, in the longitudinal direction, a bifacially rounded or sloping thickness profile.

8. The weighing system according to claim 1,
wherein the resilient region has a width that, in the longitudinal direction, initially decreases and then increases again after reaching a minimum width that is colocalized with the minimum thickness.

9. The weighing system according to claim 1,
wherein the resilient region has a length between 5 mm and 50 mm.

10. The weighing system according to claim 1,
wherein the resilient region has a thickness between 50 μm and 150 μm in the area of the minimum thickness of the resilient region.

11. The weighing system according to claim 1,
wherein the coupling belt has a plurality of the resilient regions.

12. The weighing system according to claim 11,
wherein the plurality of resilient regions are arranged parallel to each other.

13. The weighing system according to claim 1,
wherein the coupling belt has a lateral swivel area arranged in the longitudinal direction between the thin-section joint and the resilient region, consisting of at least one parallel web extending in the longitudinal direction of the coupling belt, and
wherein the at least one web has a width that is less than the thickness of the coupling belt in the lateral swivel area.

14. The weighing system according to claim 13, wherein the width of the coupling belt outside of the functional areas and outside of the lateral swivel area is between 5 mm and 10 mm.

15. The weighing system according to claim 1, wherein a length of the coupling belt is between 20 mm and 150 mm.

16. The weighing system according to claim 1, wherein the width of the coupling belt outside the functional areas is between 5 mm and 10 mm.

17. A coupling belt consisting of a sheet metal strip and configured for coupling a load receptor of a weighing system and a first lever arm of a lever of the weighing system so as to transmit vertical forces,
wherein the coupling belt has two functional areas formed at a distance from each other in a longitudinal direction of the sheet metal strip, which have a reduced width and a reduced thickness compared to areas immediately adjacent to the functional areas, namely
a thin-section joint, which has a thickness that, in the longitudinal direction of the coupling belt, initially decreases and then, after reaching a minimum thickness at a specific point, increases again in order to define a localized first pivot axis extending parallel to a width direction of the coupling belt and perpendicular to the longitudinal direction of the coupling belt, and
a resilient region which has a thickness that, in the longitudinal direction of the coupling belt, initially decreases, then, after reaching a minimum thickness, remains constant over a distance corresponding to at least a width of the coupling belt, and then increases again so as to define a continuous array of second pivot axes parallel to the first pivot axis.

18. The coupling belt according to claim 17,
wherein the resilient region comprises a plurality of resilient regions.

19. The coupling belt according to claim 18,
wherein the plurality of resilient regions are arranged parallel to each other.

20. The coupling belt according to claim 17,
produced by
providing a coupling belt blank made of a spring-elastic metal sheet,
laser processing the coupling belt blank to form length sections of different thicknesses and/or widths.
